(19) United States
(12) Patent Application Publication
(10) Pub. No.: US 2018/0018407 A1
(43) Pub. Date: Jan. 18, 2018

(54) DEPTH PEELING BASED NUCLEAR RADIATION SHIELD CALCULATION GRID GENERATION METHOD AND SYSTEM

(71) Applicant: HEFEI INSTITUTES OF PHYSICAL SCIENCE, CAS, Hefei City, Anhui (CN)

(72) Inventors: Yican WU, Hefei City, Anhui (CN); Pengcheng LONG, Hefei City, Anhui (CN); Shengpeng YU, Hefei City, Anhui (CN); Mengyun CHENG, Hefei City, Anhui (CN); Liqin HU, Hefei City, Anhui (CN)

(73) Assignee: HEFEI INSTITUTES OF PHYSICAL SCIENCE, CAS, Hefei City, Anhui (CN)

(21) Appl. No.: 15/543,154

(22) PCT Filed: Dec. 21, 2015
(86) PCT No.: PCT/CN2015/098019

§ 371 Date: Jul. 12, 2017

(30) Foreign Application Priority Data
Jan. 28, 2015 (CN) 201510044611.0

(51) Int. Cl. G06F 17/50

(52) U.S. Cl. CPC G06F 17/50; G06F 2217/16

(57) ABSTRACT

A depth peeling based nuclear radiation shield computational mesh generation method and a depth peeling based nuclear radiation shield computational mesh generation system are provided. The method includes: generating an outline pixel matrix of geometries with the depth peeling technique, performing conversion in an image space to obtain outline meshes of the geometries; then obtaining internal meshes of the geometries based on the outline meshes by a scanning line method, so as to fast generate the nuclear radiation shield computational meshes.

This application claims the priority to Chinese Patent Application No. 201510044611.0, titled “DEPTH PEELING BASED NUCLEAR RADIATION SHIELD CALCULATION GRID GENERATION METHOD AND SYSTEM”, filed on Jan. 28, 2015 with the State Intellectual Property Office of the People's Republic of China, which is incorporated herein by reference in its entirety.

### FIELD

The disclosure relates to the field of nuclear science and technology, and specifically to a depth peeling based nuclear radiation shield computational mesh generation method and a depth peeling based nuclear radiation shield computational mesh generation system.

### BACKGROUND

Neutron physics (also referred to as neutronics), which is an important branch of modern physics, mainly studies interactions between neutrons and various substances. Neutronics analysis is an important analysis method in the fields of nuclear reactor physics research, engineering design, safety assessment, optimization of fuel management, environmental monitoring and radiation shielding protection, and the like. Objects of Neutronics analysis include neutron transport, activation, burnup, dose calculation and the like, among which the neutron transport is an important basis and the core object.

Neutron transport refers to the process of neutrons moving within the medium. The neutron transport theory is a basic theory for studying the process and rule of neutron movement within the medium. With the vigorous development of nuclear energy utilization, neutron transport has become an independent basic theoretical subject in the field of nuclear science and technology, and is widely used in the fields of nuclear reactor physics, nuclear reactor shielding, and engineering application and military application of the nuclear technology. Physical quantities such as neutron density, neutron flux density and neutron current density can by acquired using neutron transport analyses.

Neutron transport researching methods are generally divided into two categories: the deterministic method and the Monte Carlo method. In the deterministic method, a mathematical model established based on physical properties of a problem is expressed by one or a group of determined mathematical physical equation, and then, these equations can be exactly or approximately solved using a mathematical method. The deterministic method is adopted for general problem in practices.

The discrete ordinate method is one of the most commonly used deterministic methods for solving the neutron transport equation. In recent years, with the rapid development of computer technology and research works, the discrete ordinate method has become one of the effective numerical methods for studying neutron transport problem, and in particular, has been widely used in shielding calculation.

In recent years, especially in the past 40 years, research institutions in countries have successively developed a series of discrete ordinate method-based program systems for assisting experts in the field to perform neutronics analysis. These program systems, which have reached a perfect level on calculation accuracy and speed, have become international universal programs, and having been widely applied in engineering. These program systems include the DOORS system (including independent transport program systems such as one-dimensional ANISN, two-dimensional DORT and three-dimensional TORT) developed by Oak Ridge National Laboratory (ORNL), the DANTSYS system (including one-dimensional ONEDANT, two-dimensional TWODANT and three-dimensional THREEDANT) and the PARTISN systems developed by Los Alamos National Laboratory (LANL) in American, the NSHEX system developed by Osaka University in Japan, the flagship product Attila developed by the US company Transpire, and the commercial software PENTRAN system developed by the US company HSW Technologies, and the like.

In the above software systems, except for Attila and PENTRAN which are developed by commercial corporations, the others are developed by research institutions and universities. At present, software systems widely used in research institutions in countries are mainly developed by research institutions, such as the DOORS system and the PARTISN system. Since these systems have a long history and adopt classic and reliable algorithms, they are used as references for verifying the effectiveness of other systems. They are also important basic tools for researchers to perform activation and dose calculation and analysis based on neutron transport.

However, these classic discrete ordinate method-based neutron transport analysis systems focus more on studies about calculation method while paying insufficient attention to program usability, and do not absorb follow-up achievements of subjects of computer graphics and scientific computing visualization since they were started in early years. Therefore, they currently cannot sufficiently support computational modeling and post-processing for large and complex cases, such that pre-processing and post-processing become significant bottlenecks for transport analysis. As a result, although the computation capacity of the computer has improved significantly, the classic systems cannot satisfy arising user requirements on complexity and precision of computational cases, which severely restrict extensive applications of the above classic discrete ordinate method-based neutron transport analysis systems.

For common practical engineering computation cases which are featured with large scale, high complexity and high precision requirements, the problem mainly lies in two aspects. In one aspect, the conventional manual text description method is not applicable. In the other aspect, due to increasingly complex spatial distribution of result data generated based on increasingly complex computation geometry, a large amount of details may be lost by adopting conventional analysis approaches based on regional averages and axial distribution, which is no longer meet the requirements.

With the continuous development of computer science, computer-aided design and scientific computing visualization have been increasingly studied by researchers at home and abroad and gradually grow mature, becoming an important research direction in computer science. The CAD technology is concerned with geometric representation, generation, operation and display, and the scientific computing visualization aims to help analysts in intuitive and efficient analysis of increasingly huge and complex computing results, and intuitively display data distribution and detailed information.

Therefore, it is important in the research field of discrete ordinate method-based neutron transport calculation and analysis tools to develop a high-efficient and high-automatic visual system which is easy to learn and easy to use, by using technologies of CAD, scientific computing visualization or other related technologies, to meet the specific requirements on the discrete ordinate method-based neutron transport analysis process, thereby simplifying pre-processing and post-processing, reducing demands on user and reducing workload, improving the analysis environment, and enhancing operation efficiency.

In neutron analysis and calculation in the nuclear field, the particle transport calculation program using the discrete ordinate method has been widely used. The main advantages of this method are that the calculation efficiency is high, an anisotropic reactor with non-uniform neutron fluence rate distribution can be calculated accurately, and the calculation result of the distribution can be acquired with this method.

However, in the existing algorithms, computational meshes based on a CAD geometric model are generated using a mesh-wise judgment method, in which the determination of relationship between dependent point for generating each mesh and CAD geometries has a high overhead. The mesh generation overall time depends on the number of the meshes, that is, a greater number of meshes indicate a greater time overhead. In nuclear reactor full space shielding calculation, there are normally hundreds or thousands subdivided meshes, and thus it takes several hours to generate computational meshes.

Therefore, although the automatic mesh generation is achieved by existing algorithms, it is difficult to effectively generate millions of three-dimensional computational meshes for complex geometries. The generation of computational meshes is still seriously time-consuming.

### SUMMARY

In view of this, a depth peeling based nuclear radiation shield computational mesh generation method and a system are provided according to the present disclosure, to overcome the problem that the computational mesh generation in the conventional technology is seriously time-consuming.

In order to solve the technical problem, the following technical solution is provided in the present disclosure.

A depth peeling based nuclear radiation shield computational mesh generation method includes:

reading a CAD geometric model generated by computer-aided software;

parsing the CAD geometric model to obtain geometries; and

generating discrete ordinate method-based particle transport computational meshes of the geometries, to generate nuclear radiation shield computational meshes,

where a generation process of the discrete ordinate method-based particle transport computational meshes for at least one of the geometries includes:

calculating an axial bounding box Box of the geometry;

generating a two-dimensional positive outline pixel matrix GeoFragPos(x,y) of the geometry downwards from an upper boundary surface of the axial bounding box Box using a depth peeling technique; and generating a two-dimensional negative outline pixel matrix GeoFragNeg(x,y) of the geometry upwards from a lower boundary surface of the axial bounding box Box using the depth peeling technique, where the two-dimensional positive outline pixel matrix GeoFragPos(x,y) records positive z-axis coordinate values zPos3D of outline pixels of the geometry in a three-dimensional coordinate system, and the two-dimensional negative outline pixel matrix GeoFragNeg(x,y) records negative z-axis coordinate values zNeg3D of outline pixels of the geometry in the three-dimensional coordinate system;

determining, based on a mesh division Mesh3D and the positive z-axis coordinate values zPos3D, a positive z-axis mesh index value ZPos of a positive outline boundary mesh BoundaryMeshPos(x,y) of the geometry in a positive axial direction, and determining, based on the mesh division Mesh3D and the negative z-axis coordinate values zNeg3D, a negative z-axis mesh index value ZNeg of a negative outline boundary mesh BoundaryMeshNeg(x,y) of the geometry in a negative axial direction; and

acquiring internal meshes of the geometry based on a three-dimensional computational mesh flag matrix MeshFlag(x, y, z) corresponding to the axial bounding box Box, the positive z-axis mesh index value ZPos, and the negative z-axis mesh index value ZNeg, by using a scan line method, where

x∈{1, 2, . . . , X}, y∈{1, 2, . . . , Y}, z∈{1, 2, . . . Z}; X is the number of meshes in a space occupied by the axial bounding box Box in an x-axis direction, Y is the number of meshes in a space occupied by the axial bounding box Box in a y-axis direction, and Z is the number of meshes in a space occupied by the axial bounding box Box in a z-axis direction.

Optionally, the acquiring the internal meshes of the geometry based on the three-dimensional computational mesh flag matrix MeshFlag(x, y, z) corresponding to the axial bounding box Box, the positive z-axis mesh index value ZPos, and the negative z-axis mesh index value ZNeg, using the scan line method may include:

step A: initializing flag values in the three-dimensional computational mesh flag matrix MeshFlag(x, y, z) corresponding to the axial bounding box Box, to 0;

step B: setting a value of x as x=1;

step C: setting a value of y as y=1;

step D: searching for the positive z-axis mesh index value ZPos of the positive outline boundary mesh BoundaryMeshPos(x,y) and the negative z-axis mesh index value ZNeg of the negative outline boundary mesh BoundaryMeshNeg(x,y) corresponding to the set value of x and the set value of y;

step E: judging whether ZPos is less than ZNeg, turning to step G in a case that ZPos is less than ZNeg, and turning to step F in a case that ZPos is not less than ZNeg;

step F: modifying flag values of meshes in the section from ZNeg to ZPos in the three-dimensional computational mesh flag matrix MeshFlag(x, y, z) corresponding to the axial bounding box Box to 1;

step G: incrementing y by 1;

step H: judging whether y is greater than Y, turning to step I in a case that y is greater than Y, and returning to step D in a case that y is not greater than Y;

step I: incrementing x by 1;

step J: judging whether x is greater than X, turning to step K in a case that x is greater than X, and returning to step C in a case that x is not greater than X; and step K: determining meshes with flag values being 1 in MeshFlag(x, y, z) as computational meshes for the geometry.

Optionally, the discrete ordinate method-based particle transport computational meshes for each of the geometries are generated with the generation process of the discrete ordinate method-based particle transport computational meshes for at least one of the geometries.

Optionally, the generating the discrete ordinate method-based particle transport computational meshes of the geometries, to generate the nuclear radiation shield computational meshes may include:

counting the number N of the obtained geometries, where N is a positive integer, and the obtained geometries are denoted as geometry i, where i∈{1, 2, . . . , N};

generating discrete ordinate method-based particle transport computational meshes for the geometry i with the generation process of the discrete ordinate method-based particle transport computational meshes for the at least one of the geometries, where an initial value of i is 1;

incrementing i by 1; and

judging whether i is greater than N, ending calculation in a case that i is greater than N, and returning to the step of generating the discrete ordinate method-based particle transport computational meshes for the geometry i with the generation process of the discrete ordinate method-based particle transport computational meshes for the at least one of the geometries in a case that i is not greater than N.

A depth peeling based nuclear radiation shield calculation mesh generation system includes:

a reading unit configured to read a CAD geometric model generated by computer-aided software;

a parsing unit configured to parse the CAD geometric model to obtain geometries; and

a generation unit configured to generate discrete ordinate method-based particle transport computational meshes of the geometries, to generate nuclear radiation shield computational meshes;

where the generation unit includes a generation subunit which includes:

a first calculation subunit configured to calculate an axial bounding box Box of the geometry;

a two-dimensional outline pixel matrix generation subunit configured to generate a two-dimensional positive outline pixel matrix GeoFragPos(x,y) of the geometry downwards from an upper boundary surface of the axial bounding box Box using a depth peeling technique; and generate a two-dimensional negative outline pixel matrix GeoFragNeg(x,y) of the geometry upwards from a lower boundary surface of the axial bounding box Box using the depth peeling technique, where the two-dimensional positive outline pixel matrix

GeoFragPos(x,y) records positive z-axis coordinate values zPos3D of outline pixels of the geometry in the three-dimensional coordinate system, and the two-dimensional negative outline pixel matrix GeoFragNeg(x,y) records negative z-axis coordinate values zNeg3D of outline pixels of the geometry in the three-dimensional coordinate system;

a first determination subunit configured to determine, based on a mesh division Mesh3D and the positive z-axis coordinate values zPos3D, a positive z-axis mesh index value ZPos of a positive outline boundary mesh BoundaryMeshPos(x,y) of the geometry in a positive axial direction, and determine, based on the mesh division Mesh3D and the negative z-axis coordinate values zNeg3D, a negative z-axis mesh index value ZNeg of a negative outline boundary mesh BoundaryMeshNeg(x,y) of the geometry in a negative axial direction; and a first calculation subunit configured to acquire internal meshes of the geometry based on a three-dimensional computational mesh flag matrix MeshFlag(x, y, z) corresponding to the axial bounding box Box, the positive z-axis mesh index value ZPos, and the negative z-axis mesh index value ZNeg, by using a scan line method, where

x∈{1, 2, . . . , X}, y∈{1, 2, . . . , Y}, z∈{1, 2, . . . , Z}; X is the number of meshes in a space occupied by the axial bounding box Box in an x-axis direction, Y is the number of meshes in a space occupied by the axial bounding box Box in a y-axis direction, and Z is the number of meshes in a space occupied by the axial bounding box Box in a z-axis direction.

Optionally, the first calculation subunit may include:

an initialization subunit configured to initialize flags in the three-dimensional computational mesh flag matrix MeshFlag(x, y, z) corresponding to the axial bounding box, to 0;

a first setting subunit configured to set a value of x as x=1;

a second setting subunit configured to set a value of y as y=1;

a searching subunit configured to search for the positive z-axis mesh index value ZPos of the positive outline boundary mesh BoundaryMeshPos(x,y) and the negative z-axis mesh index value ZNeg of the negative outline boundary mesh BoundaryMeshNeg(x,y) corresponding to the set value of x and the set value of y;

a first judgment subunit configured to judge whether ZPos is less than ZNeg;

a third setting subunit configured to increment y by 1 in a case of the first judgment subunit judging that ZPos is less than ZNeg;

a flag value modification subunit configured to modify flag values of meshes in the section from ZNeg to ZPos in the three-dimensional computational mesh flag matrix MeshFlag(x, y, z) corresponding to the axial bounding box Box to 1, and trigger the third setting subunit, in a case of the first judgment subunit judging that ZPos is not less than ZNeg;

a second judgment subunit configured to judge whether y is greater than Y, where the searching subunit is triggered in a case of the second judgment subunit judging that y is not greater than Y;

a fourth setting subunit configured to increment x by 1 in a case of the second judgment subunit judging that y is greater than Y;

a third judgment subunit configured to judge whether x is greater than X, where the second setting subunit is triggered in a case that x is not greater than X; and

a second determination subunit configured to determine meshes with flags being 1 in MeshFlag(x, y, z) as computational meshes for the geometry in a case of the third judgment subunit judging that x is greater than X.

Optionally, the generation unit may further include:

a counting subunit configured to count the number N of the obtained geometries, where N is a positive integer, the obtained geometries are denoted as a geometry i, where i∈{1, 2, . . . , N}, and the generation subunit is configured to generate discrete ordinate method-based particle transport computational meshes for the geometry i, where an initial value of i is 1;

a fifth setting subunit configured to increment i by 1; and

a fourth judgment subunit configured to judge whether i is greater than N, where calculation is ended in a case that i is greater than N, and the generation subunit is triggered to generate the discrete ordinate method-based particle transport computational meshes for the geometry i in a case that i is not greater than N.

As compared with the conventional technology, the present disclosure has the following advantageous effects.

In the nuclear radiation shield computational mesh generation method provided according to the present disclosure, the time-consuming geometry relationship judgment problem in a three-dimensional graphics space is converted to a pixel processing problem in the two-dimensional space by using the generation process of discrete ordinate method-based particle transport computational meshes for a geometry. Thus the difficulty of processing and the time consumption are reduced.

In addition, the depth peeling technique is employed in the present disclosure to extract the boundary surfaces of a three-dimensional geometric model and converts them into two-dimensional pixel images using a graphics processing unit GPU. Therefore, with the method according to the present disclosure, the high-efficient processing performance of the GPU hardware technology is fully utilized, such that the boundary surface information of the three-dimensional geometric model can be acquired rapidly.

With the method of the present disclosure, meshes corresponding to the internal space of the three-dimensional geometry can be acquired by scanning meshes corresponding to the boundary of the geometry instead of direct judgment, thereby avoiding the time-consuming judgment of massive geometry relationships, thus reducing the amount of calculation, so as to generate the correspondence between the geometry internal space and the computational meshes rapidly.

### BRIEF DESCRIPTION OF THE DRAWINGS

The drawings to be used in the description of the embodiments of the application will be described briefly as follows, so that the technical solutions according to the embodiments of the present application will become clearer. It is apparent that the drawings in the following description only illustrate some embodiments of the present application. For those skilled in the art, other drawings may be obtained according to these drawings without any creative work.

FIG. 1 is a flow chart of a depth peeling based nuclear radiation shield computational mesh generation method according to an embodiment of the present disclosure;

FIG. 2 is a flow chart of a specific implementation of the step S107 according to an embodiment of the present disclosure;

FIG. 3 is a schematic structural diagram of a depth peeling based nuclear radiation shield computational mesh generation system according to an embodiment of the present disclosure;

FIG. 4 is a schematic structural diagram of a first calculation subunit according to an embodiment of the present disclosure; and

FIG. 5 is a schematic structural diagram of a generation unit according to an embodiment of the present disclosure.

### DETAILED DESCRIPTION OF THE EMBODIMENTS

In order that the objectives, technical solutions and advantages of the present disclosure can be clearer, the embodiments of the present disclosure will be described in detail in the following in conjunction with the drawings.

Before describing the embodiments of the present disclosure, the depth peeling technique is introduced.

Depth Peeling is a technology for sorting depth values. The principle thereof is simple: in standard depth detection, a point with the smallest Z value in a scene, which is a vertex closest to the viewer, is outputted to the screen. Then, in order to display a second closest vertex and a third closest vertex with respect to the viewer, the multi-pass rendering method is adopted. Depth peeling is based on z-buffer multilayer rendering, where rendering of each layer is based on the depth value of the rendering of a previous layer.

The basic idea of the depth peeling technique is to render the scene pass by pass. Each pass of rendering goes into a deeper layer of the scene than a previous pass, thereby successively acquiring the nearest, the second nearest, the third nearest, . . . , the Nth nearest fragment of each pixel. Then, all fragments are finally synthesized using a synthesis technology to acquire the final color of the pixel, thereby acquiring the final image. Depth peeling is invented for performing transparency rendering of an object, with which proper transparency rendering can be acquired without sorting triangular facets. After being implied in Nvidia Geforce3, the transparency rendering based on the depth peeling technique has gained more and more attention.

Depth peeling has the working principle of plotting the geometry several times to accumulate the final result. Each iteration of the plotting peels off a single plane depth layer which is visible through each pixel. The advantage of this core algorithm over the painter's algorithm is that it is not necessary to presort the geometric primitives.

With the improvement of the capability and complexity of personal computer systems, more and more specialized graphic plotting devices called graphics processing units (GPUs) are used to perform graphical operations such as graphical operations required for Z-buffering, deep peeling, and rasterization. The GPU is generally used in a removable graphics card which is coupled to the motherboard via a standard bus (for example, AGP or PCI Express). Although the GPUs are different in capability, they can generally be used to perform tasks of plotting of two-dimensional (2D) graphic data, plotting of three-dimensional (3D) graphic data, and accelerated plotting of graphical user interface (GUI) display elements. The GPU can implement one or more application program interfaces (APIs) that allow the programmer to invoke the functionality of the GPU.

The GPU may include various built-in and configurable structures for plotting digital images to an imaging device.

In the deep peeling technology employed in the embodiments of the present disclosure, the GPU is utilized to extract boundary surfaces of a three-dimensional geometric model.

For a clearer understanding of the technical solution of the present disclosure, some technical terms used in the embodiments of the present disclosure are described below.

Radiation transport (also referred to as particle transport) refers to the process of radiation particles (such as neutrons, photons, electrons, protons, etc.) moving within the medium. The radiation transport theory is the basic theory for studying the process and rule of particle movement within the medium. Physical quantities such as particle integral flow rate, flux density and nuclear heat deposition can be acquired using radiation transport simulation calculation. With the vigorous development of nuclear energy utilization, radiation transport has become an independent basic theoretical subject in the field of nuclear science and technology, and is widely used in the fields of nuclear reactor physics, radiation shielding and protection, and engineering application of nuclear technology.

Radiation transport calculation programs (such as MCNP and TRIPOLI) have been widely used in the fields of reactor physics, radiation shielding and protection, nuclear detection, and emission dosimetry. The method of establishing the Monte Carlo model using the conventional manual text is time-consuming and error-prone, and is difficult to be used for modeling complex system geometry.

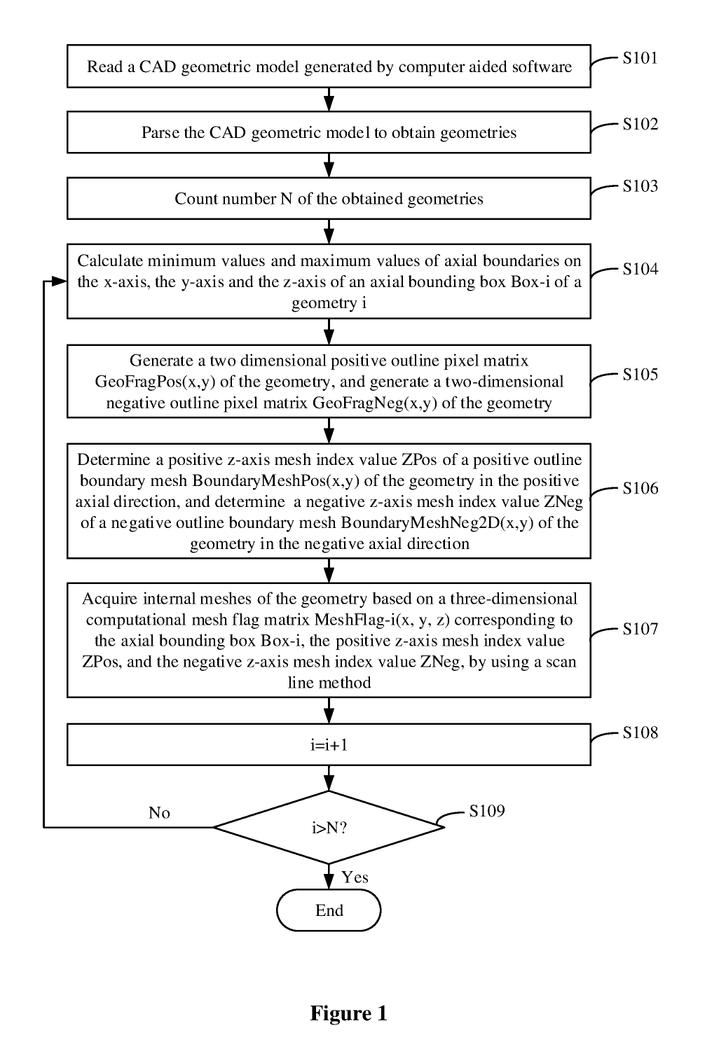

FIG. 1 is a flow chart of a depth peeling based nuclear radiation shield computational mesh generation method according to the embodiment of the present disclosure. As shown in FIG. 1, the method includes the following steps S101 to S109.

In step S101, a CAD geometric model generated by computer-aided software is read.

In step S102, the CAD geometric model are parsed to obtain geometries.

The CAD geometric model is a three-dimensional module which is generally constituted by at least one geometry. The obtained geometries may be a cylinder, a sphere, a cuboid, a cube and the like, depending on the CAD geometric model.

In step S103, the number N of the obtained geometries are counted, where N is a positive integer, and the obtained geometries are denoted as geometry i, i.e., Geo-I, where i∈{1, 2, . . . , N}.

In step 5104, minimum values and maximum values of axial boundaries on the x-axis, the y-axis and the z-axis of an axial bounding box Box-i of a geometry i are calculated.

Specifically, this step includes: calculating a minimum value xₘᵢₙ and a maximum value xₘₐₓ of the axial boundary on the x-axis, a minimum value yₘᵢₙ, and a maximum value yₘₐₓ of the axial boundary on the y-axis, and a minimum value zₘᵢₙ, and a maximum value zₘₐₓ of the axial boundary on the z-axis in the three-dimensional coordinate system of the axial bounding box Box-i of the geometry i. In the embodiment of the present disclosure, the initial value of i is 1.

In step S105, a two-dimensional positive outline pixel matrix GeoFragPos(x,y) of the geometry is generated downwards from an upper boundary surface of the axial bounding box Box using a depth peeling technique; and a two-dimensional negative outline pixel matrix GeoFragNeg(x,y) of the geometry is generated upwards from a lower boundary surface of the axial bounding box Box using the depth peeling technique.

It is noted that, in the embodiments of the present disclosure, the axial direction of the axial bounding box Box-i is the z-axis direction. Therefore, the upper boundary surface of the axial bounding box Box-i is an x-y boundary surface located on the positive z-axis. Similarly, the lower boundary surface is an x-y boundary surface located on the negative z-axis.

Specifically, in this step, generating the two-dimensional positive outline pixel matrix GeoFragPos(x,y) of the geometry GEO-i downwards from the upper boundary surface of the axial bounding box Box-i using the depth peeling technique includes: perpendicularly projecting the x-y boundary surface of the axial bounding box Box-i located on the positive z-axis on the x-y plane, to generate the two-dimensional positive outline pixel matrix GeoFragPos(x,y) of the geometry.

Similarly, the two-dimensional negative outline pixel matrix GeoFragNeg(x,y) of the geometry is generated upwards from a lower boundary surface of the axial bounding box Box-i using the depth peeling technique.

The two-dimensional positive outline pixel matrix GeoFragPos(x,y) records positive z-axis coordinate values zPos3D of outline pixels of the geometry in the three-dimensional coordinate system, and the two-dimensional negative outline pixel matrix GeoFragNeg(x,y) records negative z-axis coordinate values zNeg3D of outline pixels of the geometry in the three-dimensional coordinate system.

In step S106, a positive z-axis mesh index value ZPos of a positive outline boundary mesh BoundaryMeshPos(x,y) of the geometry in the positive axial direction is determined based on a mesh division Mesh3D and the positive z-axis coordinate values zPos3D, and a negative z-axis mesh index value ZNeg of a negative outline boundary mesh BoundaryMeshNeg2D(x,y) of the geometry in the negative axial direction is determined based on the mesh division Mesh3D and the negative z-axis coordinate values zNeg3D.

It is noted that, the three-dimensional coordination system where the geometry is located is meshed according to a predetermined mesh division rule Mesh3D, to acquire meshes corresponding to a space occupied by the axial bounding box Box-i of the geometry.

It is noted that, the positive outline boundary mesh BoundaryMeshPos(x,y) of the geometry Geo-i in the positive axial direction may be acquired by denoting Mesh3D meshes covered by the upper surface over the z-axis of the axial bounding box Box-i as the positive outline boundary mesh BoundaryMeshPos(x,y) of the geometry Geo-i in the positive axial direction.

Similarly, Mesh3D meshes covered by the lower surface below the z-axis of the axial bounding box Box-i are denoted as the negative outline boundary mesh BoundaryMeshNeg(x,y) of the geometry Geo-i in the negative axial direction.

The positive z-axis mesh index value ZPos of BoundaryMeshPos(x,y) can be determined based on the generated BoundaryMeshPos(x,y) and the positive z-axis coordinate values zPos3D of GeoFragPos(x,y).

It is noted that, specifically, the positive z-axis mesh index value ZPos is a mesh index value in the z-axis direction corresponding to a space where the meshed axial bounding box is located. For example, assuming that the meshes in the z-axis direction corresponding to the space where the meshed axial bounding box is located are a third mesh to a tenth mesh, the positive z-axis mesh index value ZPos is 10.

Similar to the positive z-axis mesh index value ZPos, in the graphics space, the negative z-axis mesh index value ZNeg of the negative outline boundary mesh BoundaryMeshNeg(x,y) of the geometry in the negative axial direction can be determined based on the negative z-axis coordinate values zNeg3D recorded in the two-dimensional negative outline pixel matrix GeoFragNeg(x,y).

In S107, internal meshes of the geometry are acquired based on a three-dimensional computational mesh flag matrix MeshFlag-i(x, y, z) corresponding to the axial bounding box Box-i, the positive z-axis mesh index value ZPos, and the negative z-axis mesh index value ZNeg, by using a scan line method.

In MeshFlag-i(x, y, z), x∈{1, 2, . . . , X}, y∈{1, 2, . . . , Y}, z∈{1, 2, . . . , Z}; X is the number of meshes in the space occupied by the axial bounding box Box-i in an x-axis direction, Y is the number of meshes in the space occupied by the axial bounding box Box-i in the y-axis direction, and Z is the number of meshes in the space occupied by the axial bounding box Box-i in the z-axis direction.

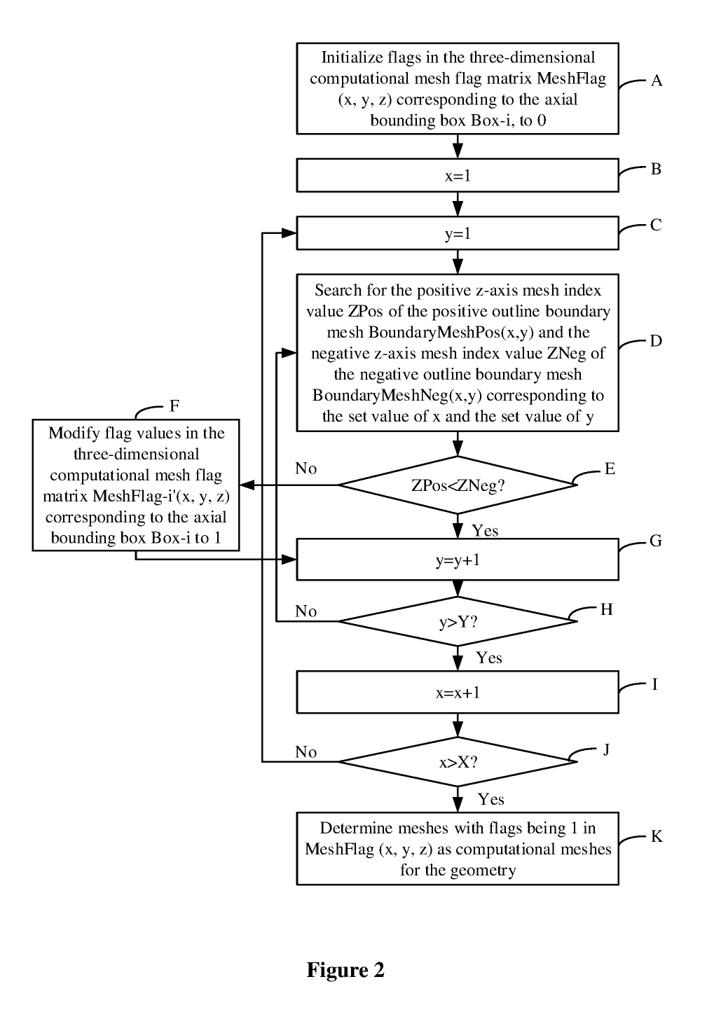

As an example, a specific implementation of step S107 is shown in FIG. 2, which includes the following steps A to K.

In step A, flags in the three-dimensional computational mesh flag matrix MeshFlag-i(x, y, z) corresponding to the axial bounding box Box-i are initialized, to 0.

In step B, a value of x is set as x=1.

In step C, a value of y is set as y−1.

In step D, the positive z-axis mesh index value ZPos of the positive outline boundary mesh BoundaryMeshPos (x,y) and the negative z-axis mesh index value ZNeg of the negative outline boundary mesh BoundaryMeshNeg(x,y) corresponding to the set value of x and the set value of y are searched for.

In step E, it is judged whether ZPos is less than ZNeg. Step G is performed in a case that ZPos is less than ZNeg, and step F is performed in a case that ZPos is not less than ZNeg;

In step F, flag values of meshes in the section from ZNeg to ZPos in the three-dimensional computational mesh flag matrix MeshFlag(x, y, z) corresponding to the axial bounding box Box are modified to 1.

In step G, y is incremented by 1.

In step H, it is judged whether y is greater than Y. Step I is performed in a case that y is greater than Y, and the process returns to step D in a case that y is not greater than Y.

In step I, x is incremented by 1.

In step J, it is judged whether x is greater than X. Step K is performed in a case that x is greater than X, and the process returns to step C in a case that x is not greater than X.

In step K, meshes with flags being 1 in MeshFlag-i(x, y, z) are determined as computational meshes for the geometry.

In S108, i is incremented by 1.

In S109, it is determined whether i is greater than N, the calculation is ended in a case that i is greater than N, and the calculation returns to step S104 in a case that i is not greater than N.

An embodiment of the depth peeling based nuclear radiation shield computational mesh generation method according to the present disclosure is described above. In this embodiment, steps S103 to S107 is a process for generating discrete ordinate method-based particle transport computational meshes for a geometry. Computational meshes are generated for each of the geometries constituting the CAD geometric model using the method illustrated by steps S103 to S107. In fact, as long as computational meshes are generated for one of the geometries using the method illustrated by steps S103 to S107, it is within the scope of the present disclosure.

As can be seen from the above embodiment, in the nuclear radiation shield computational mesh generation method provided according to the present disclosure, the time-consuming geometry relationship judgment problem in a three-dimensional graphics space is converted to a pixel processing problem in the two-dimensional space using the generation process of discrete ordinate method-based particle transport computational meshes for at least one geometry. Thus the difficulty of processing and the time consumption are reduced.

In addition, the depth peeling technique is employed in the present disclosure to extract the boundary surfaces of a three-dimensional geometric model and converts them into two-dimensional pixel images using a graphics processing unit GPU. Therefore, with the method according to the present disclosure, the high-efficient processing performance of the GPU hardware technology is fully utilized, such that the boundary surface information of the three-dimensional geometric model can be acquired rapidly.

With the method of the present disclosure, meshes corresponding to the internal space of the three-dimensional geometry can be acquired by scanning meshes corresponding to the boundary of the geometry instead of direct judgment, thereby avoiding the time-consuming judgment of massive geometry relationships, thus reducing the amount of calculation, so as to generate the correspondence between the geometry internal space and the computational meshes rapidly.

Based on the depth peeling based nuclear radiation shield computational mesh generation method according to the embodiment of the present disclosure, it is further provided a depth peeling based nuclear radiation shield computational mesh generation system according to the embodiment of the present disclosure, which is described in the following embodiment.

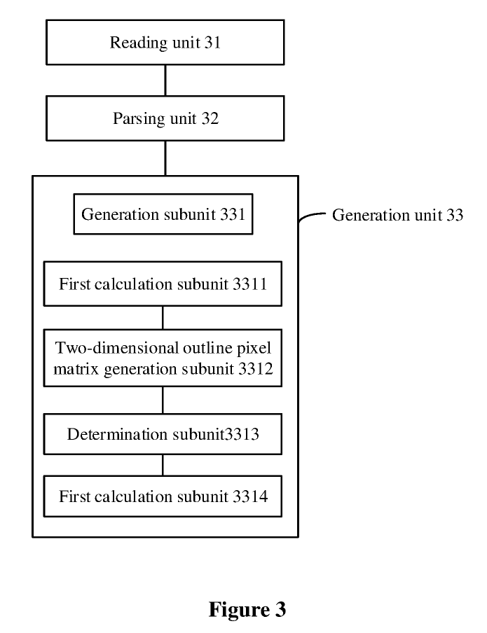

FIG. 3 is a schematic structural diagram of a depth peeling based nuclear radiation shield computational mesh generation system according to the embodiment of the present disclosure.

As shown in FIG. 3, the generation system includes a reading unit 31, a parsing unit 32 and a generation unit 33.

The reading unit 31 is configured to read a CAD geometric model generated by computer-aided software.

The parsing unit 32 is configured to parse the CAD geometric model to obtain geometries.

The generation unit 33 is configured to generate discrete ordinate method-based particle transport computational meshes of the geometries, to generate nuclear radiation shield computational meshes.

The generation unit includes a generation subunit 331 which includes a first calculation subunit 3311, a two-dimensional outline pixel matrix generation subunit 3312, a first determination subunit 3313, and a first calculation subunit 3314.

The first calculation subunit 3311 is configured to calculate an axial bounding box Box of the geometry.

The two-dimensional outline pixel matrix generation subunit 3312 is configured to generate a two-dimensional positive outline pixel matrix GeoFragPos(x,y) of the geometry downwards from an upper boundary surface of the axial bounding box Box using a depth peeling technique; and generate a two-dimensional negative outline pixel matrix GeoFragNeg(x,y) of the geometry upwards from a lower boundary surface of the axial bounding box Box using the depth peeling technique, where the two-dimensional positive outline pixel matrix GeoFragPos(x,y) records positive z-axis coordinate values zPos3D of outline pixels of the geometry in the three-dimensional coordinate system, and the two-dimensional negative outline pixel matrix GeoFragNeg(x,y) records negative z-axis coordinate values zNeg3D of outline pixels of the geometry in the three-dimensional coordinate system.

The first determination subunit 3313 is configured to determine, based on a mesh division Mesh3D and the positive z-axis coordinate values zPos3D, a positive z-axis mesh index value ZPos of a positive outline boundary mesh BoundaryMeshPos(x,y) of the geometry in a positive axial direction in the graphic space, and determine, based on the mesh division Mesh3D and the negative z-axis coordinate values zNeg3D, a negative z-axis mesh index value ZNeg of a negative outline boundary mesh BoundaryMeshNeg(x,y) of the geometry in a negative axial direction in the graphic space.

The first calculation subunit 3314 is configured to acquire internal meshes of the geometry based on a three-dimensional computational mesh flag matrix MeshFlag(x, y, z) corresponding to the axial bounding box Box, the positive z-axis mesh index value ZPos, and the negative z-axis mesh index value ZNeg, by using a scan line method.

In the above, x∈{1, 2, . . . , X}, y∈{1, 2, . . . , Y}, z∈{1, 2, . . . , Z}, X is the number of meshes in a space occupied by the axial bounding box Box in an x-axis direction, Y is the number of meshes in a space occupied by the axial bounding box Box in a y-axis direction, and Z is the number of meshes in a space occupied by the axial bounding box Box in a z-axis direction.

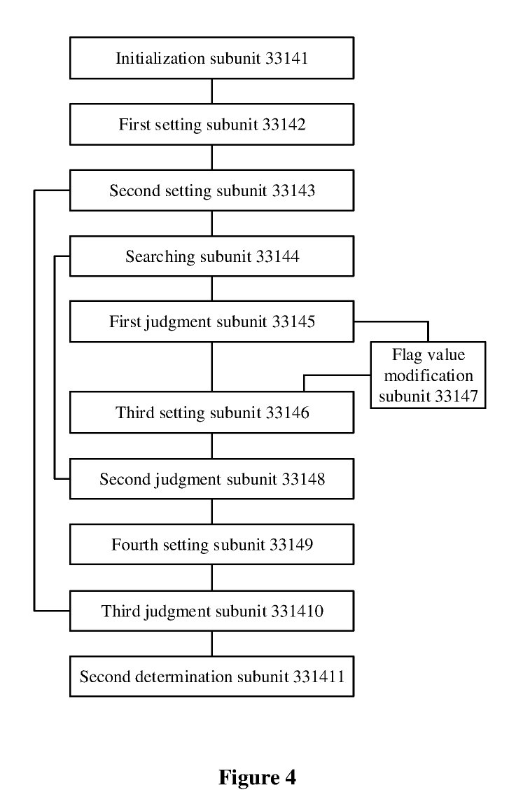

As an embodiment of the present disclosure, a specific structure of the above described first calculation subunit 3314 is shown in FIG. 4, which includes the subunits 33141 to 331411.

An initialization subunit 33141 is configured to initialize flags in the three-dimensional computational mesh flag matrix MeshFlag(x, y, z) corresponding to the axial bounding box, to 0.

A first setting subunit 33142 is configured to set a value of x as x=1.

A second setting subunit 33143 is configured to set a value of y as y=1.

A searching subunit 33144 is configured to search for the positive z-axis mesh index value ZPos of the positive outline boundary mesh BoundaryMeshPos(x,y) and the negative z-axis mesh index value ZNeg of the negative outline boundary mesh BoundaryMeshNeg(x,y) corresponding to the set value of x and the set value of y.

A first judgment subunit 33145 is configured to judge whether ZPos is less than ZNeg;

A third setting subunit 33146 is configured to increment y by 1 in a case of the first judgment subunit judging that ZPos is less than ZNeg.

A flag value modification subunit 33147 is configured to modify flag values of meshes in the section from ZNeg to ZPos in the three-dimensional computational mesh flag matrix MeshFlag-i(x, y, z) corresponding to the axial bounding box Box to 1, and trigger the third setting subunit 33146, in a case of the first judgment subunit judging that ZPos is not less than ZNeg.

A second judgment subunit 33148 is configured to judge whether y is greater than Y, where the searching subunit 33144 is triggered in a case of the second judgment subunit judging that y is not greater than Y.

A fourth setting subunit 33149 is configured to increment x by 1 in a case of the second judgment subunit judging that y is greater than Y.

A third judgment subunit 331410 is configured to judge whether x is greater than X, where the second setting subunit 33143 is triggered in a case that x is not greater than X.

A second determination subunit 331411 is configured to determine meshes with flags being 1 in MeshFlag-i(x, y, z) as computational meshes for the geometry in a case of the third judgment subunit 33149 judging that x is greater than X.

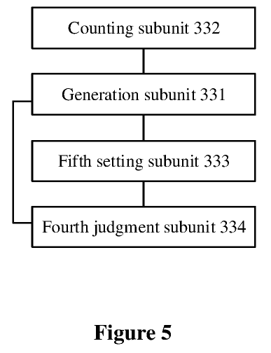

As an embodiment of the present disclosure, in order that computational meshes for all obtained geometries are generated using the generation method according to the above embodiment, the generation unit 33 may further include a counting subunit 332, a fifth setting subunit 333 and a fourth judgment subunit 334 in addition to the generation subunit 331, as shown in FIG. 5.

The counting subunit 332 is configured to count the number N of the obtained geometries, where N is a positive integer, and the obtained geometries are denoted as geometry i, where i∈{1, 2, . . . , N}.

The generation subunit 331 is configured to generate discrete ordinate method-based particle transport computational meshes for the geometry i, where an initial value of i is 1.

The fifth setting subunit 333 is configured to increment i by 1.

The fourth judgment subunit 334 is configured to judge whether i is greater than N, where calculation is ended in a case that i is greater than N, and the generation subunit is triggered to generate the discrete ordinate method-based particle transport computational meshes for the geometry i in a case that i is not greater than N.

The above are preferred embodiments of the present disclosure. It should be understood that any modifications and variations of the above-described embodiments made by those skilled in the art without departing from the spirit of the present disclosure fall within the scope of the present disclosure.

1. A depth peeling based nuclear radiation shield computational mesh generation method, comprising:
reading a CAD geometric model generated by computer-aided software;
parsing the CAD geometric model to obtain geometries; and
generating discrete ordinate method-based particle transport computational meshes of the geometries, to generate nuclear radiation shield computational meshes,
wherein a generation process of the discrete ordinate method-based particle transport computational meshes for at least one of the geometries comprises:
calculating an axial bounding box Box of the geometry;
generating a two-dimensional positive outline pixel matrix GeoFragPos(x,y) of the geometry downwards from an upper boundary surface of the axial bounding box Box using a depth peeling technique; and generating a two-dimensional negative outline pixel matrix GeoFragNeg(x,y) of the geometry upwards from a lower boundary surface of the axial bounding box Box using the depth peeling technique, wherein the two-dimensional positive outline pixel matrix GeoFragPos(x,y) records positive z-axis coordinate values zPos3D of outline pixels of the geometry in a three-dimensional coordinate system, and the two-dimensional negative outline pixel matrix GeoFragNeg(x,y) records negative z-axis coordinate values zNeg3D of outline pixels of the geometry in the three-dimensional coordinate system;
determining, based on a mesh division Mesh3D and the positive z-axis coordinate values zPos3D, a positive z-axis mesh index value ZPos of a positive outline boundary mesh BoundaryMeshPos(x,y) of the geometry in a positive axial direction, and determining, based on the mesh division Mesh3D and the negative z-axis coordinate values zNeg3D, a negative z-axis mesh index value ZNeg of a negative outline boundary mesh BoundaryMeshNeg(x,y) of the geometry in a negative axial direction; and
acquiring internal meshes of the geometry based on a three-dimensional computational mesh flag matrix MeshFlag(x, y, z) corresponding to the axial bounding box Box, the positive z-axis mesh index value ZPos, and the negative z-axis mesh index value ZNeg, by using a scan line method, wherein
x∈{1, 2, . . . , X}, y∈{1, 2, . . . , Y}, z∈{1, 2, . . . , Z}; X is the number of meshes in a space occupied by the axial bounding box Box in an x-axis direction, Y is the number of meshes in a space occupied by the axial bounding box Box in a y-axis direction, and Z is the number of meshes in a space occupied by the axial bounding box Box in a z-axis direction.

2. The method according to claim 1, wherein the acquiring the internal meshes of the geometry based on the three-dimensional computational mesh flag matrix MeshFlag(x, y, z) corresponding to the axial bounding box Box, the positive z-axis mesh index value ZPos, and the negative z-axis mesh index value ZNeg, using the scan line method comprises:
step A: initializing flag values in the three-dimensional computational mesh flag matrix MeshFlag(x, y, z) corresponding to the axial bounding box Box, to 0;
step B: setting a value of x as x=1;
step C: setting a value of y as y=1;
step D: searching for the positive z-axis mesh index value ZPos of the positive outline boundary mesh BoundaryMeshPos(x,y) and the negative z-axis mesh index value ZNeg of the negative outline boundary mesh BoundaryMeshNeg(x,y) corresponding to the set value of x and the set value of y;
step E: judging whether ZPos is less than ZNeg, turning to step G in a case that ZPos is less than ZNeg, and turning to step F in a case that ZPos is not less than ZNeg;
step F: modifying flag values of meshes in the section from ZNeg to ZPos in the three-dimensional computational mesh flag matrix MeshFlag(x, y, z) corresponding to the axial bounding box Box to 1;
step G: incrementing y by 1;
step H: judging whether y is greater than Y, turning to step I in a case that y is greater than Y, and returning to step D in a case that y is not greater than Y;
step I: incrementing x by 1;
step J: judging whether x is greater than X, turning to step K in a case that x is greater than X, and returning to step C in a case that x is not greater than X; and
step K: determining meshes with flag values being 1 in MeshFlag(x, y, z) as computational meshes for the geometry.

3. The method according to claim 1, wherein the discrete ordinate method-based particle transport computational meshes for each of the geometries are generated with the generation process of the discrete ordinate method-based particle transport computational meshes for the at least one of the geometries.

4. The method according to claim 3, wherein the generating the discrete ordinate method-based particle transport computational meshes of the geometries, to generate the nuclear radiation shield computational meshes comprises:
counting the number N of the obtained geometries, wherein N is a positive integer, and the obtained geometries are denoted as geometry i, wherein i∈{1, 2, . . . , N};
generating discrete ordinate method-based particle transport computational meshes for the geometry i with the generation process of the discrete ordinate method-based particle transport computational meshes for the at least one of the geometries, wherein an initial value of i is 1;
incrementing i by 1; and
judging whether i is greater than N, ending calculation in a case that i is greater than N, and returning to the step of generating the discrete ordinate method-based particle transport computational meshes for the geometry i with the generation process of the discrete ordinate method-based particle transport computational meshes for the at least one of the geometries in a case that i is not greater than N.

5. A depth peeling based nuclear radiation shield computational mesh generation system, comprising:
a reading unit configured to read a CAD geometric model generated by computer-aided software;
a parsing unit configured to parse the CAD geometric model to obtain geometries; and
a generation unit configured to generate discrete ordinate method-based particle transport computational meshes of the geometries, to generate nuclear radiation shield computational meshes;
wherein the generation unit comprises a generation subunit which comprises:
a first calculation subunit configured to calculate an axial bounding box Box of the geometry;
a two-dimensional outline pixel matrix generation subunit configured to generate a two-dimensional positive outline pixel matrix GeoFragPos(x,y) of the geometry downwards from an upper boundary surface of the axial bounding box Box using a depth peeling technique; and generate a two-dimensional negative outline pixel matrix GeoFragNeg(x,y) of the geometry upwards from a lower boundary surface of the axial bounding box Box using the depth peeling technique, wherein the two-dimensional positive outline pixel matrix GeoFragPos(x,y) records positive z-axis coordinate values zPos3D of outline pixels of the geometry in a three-dimensional coordinate system, and the two-dimensional negative outline pixel matrix GeoFragNeg(x,y) records negative z-axis coordinate values zNeg3D of outline pixels of the geometry in the three-dimensional coordinate system;
a first determination subunit configured to determine, based on a mesh division Mesh3D and the positive z-axis coordinate values zPos3D, a positive z-axis mesh index value ZPos of a positive outline boundary mesh BoundaryMeshPos(x,y) of the geometry in a positive axial direction, and determine, based on the mesh division Mesh3D and the negative z-axis coordinate values zNeg3D, a negative z-axis mesh index value ZNeg of a negative outline boundary mesh BoundaryMeshNeg(x,y) of the geometry in a negative axial direction; and
a first calculation subunit configured to acquire internal meshes of the geometry based on a three-dimensional computational mesh flag matrix MeshFlag(x, y, z) corresponding to the axial bounding box Box, the positive z-axis mesh index value ZPos, and the negative z-axis mesh index value ZNeg, by using a scan line method, wherein
x∈{1, 2, . . . , X}, y∈{1, 2, . . . , Y}, z∈{1, 2, . . . , Z}; X is the number of meshes in a space occupied by the axial bounding box Box in an x-axis direction, Y is the number of meshes in a space occupied by the axial bounding box Box in a y-axis direction, and Z is the number of meshes in a space occupied by the axial bounding box Box in a z-axis direction.

6. The system according to claim 5, wherein the first calculation subunit comprises:
an initialization subunit configured to initialize flags in the three-dimensional computational mesh flag matrix MeshFlag(x, y, z) corresponding to the axial bounding box, to 0;
a first setting subunit configured to set a value of x as x=1;
a second setting subunit configured to set a value of y as y=1;
a searching subunit configured to search for the positive z-axis mesh index value ZPos of the positive outline boundary mesh BoundaryMeshPos(x,y) and the negative z-axis mesh index value ZNeg of the negative outline boundary mesh BoundaryMeshNeg(x,y) corresponding to the set value of x and the set value of y;
a first judgment subunit configured to judge whether ZPos is less than ZNeg;
a third setting subunit configured to increment y by 1 in a case of the first judgment subunit judging that ZPos is less than ZNeg;
a flag value modification subunit configured to modify flag values of meshes in the section from ZNeg to ZPos in the three-dimensional computational mesh flag matrix MeshFlag(x, y, z) corresponding to the axial bounding box Box to 1, and trigger the third setting subunit, in a case of the first judgment subunit judging that ZPos is not less than ZNeg;
a second judgment subunit configured to judge whether y is greater than Y, wherein the searching subunit is triggered in a case of the second judgment subunit judging that y is not greater than Y;
a fourth setting subunit configured to increment x by 1 in a case of the second judgment subunit judging that y is greater than Y;
a third judgment subunit configured to judge whether x is greater than X, wherein the second setting subunit is triggered in a case that x is not greater than X; and
a second determination subunit configured to determine meshes with flags being 1 in MeshFlag(x, y, z) as computational meshes for the geometry in a case of the third judgment subunit judging that x is greater than X.

7. The system according to claim 5, wherein the generation unit further comprises:
a counting subunit configured to count the number N of the obtained geometries, wherein N is a positive integer, the obtained geometries are denoted as geometry i, wherein i∈{1, 2, . . . , N}, the generation subunit is configured to generate discrete ordinate method-based particle transport computational meshes for the geometry i, wherein an initial value of i is 1;
a fifth setting subunit configured to increment i by 1; and
a fourth judgment subunit configured to judge whether i is greater than N, wherein calculation is ended in a case that i is greater than N, and the generation subunit is triggered to generate the discrete ordinate method-based particle transport computational meshes for the geometry i in a case that i is not greater than N.

8. The method according to claim 2, wherein the discrete ordinate method-based particle transport computational meshes for each of the geometries are generated with the generation process of the discrete ordinate method-based particle transport computational meshes for the at least one of the geometries.

9. The method according to claim 8, wherein the generating the discrete ordinate method-based particle transport computational meshes of the geometries, to generate the nuclear radiation shield computational meshes comprises:
counting the number N of the obtained geometries, wherein N is a positive integer, and the obtained geometries are denoted as geometry i, wherein i∈{1, 2, . . . , N};
generating discrete ordinate method-based particle transport computational meshes for the geometry i with the generation process of the discrete ordinate method-based particle transport computational meshes for the at least one of the geometries, wherein an initial value of i is 1;
incrementing i by 1; and
judging whether i is greater than N, ending calculation in a case that i is greater than N, and returning to the step of generating the discrete ordinate method-based particle transport computational meshes for the geometry i with the generation process of the discrete ordinate method-based particle transport computational meshes for the at least one of the geometries in a case that i is not greater than N.

10. The system according to claim 6, wherein the generation unit further comprises:
a counting subunit configured to count the number N of the obtained geometries, wherein N is a positive integer, the obtained geometries are denoted as geometry i, wherein i∈{1, 2, . . . , N}, the generation subunit is configured to generate discrete ordinate method-based particle transport computational meshes for the geometry i, wherein an initial value of i is 1;
a fifth setting subunit configured to increment i by 1; and
a fourth judgment subunit configured to judge whether i is greater than N, wherein calculation is ended in a case that i is greater than N, and the generation subunit is triggered to generate the discrete ordinate method-based particle transport computational meshes for the geometry i in a case that i is not greater than N.
